(19) United States
(12) Patent Application Publication
(10) Pub. No.: US 2015/0326053 A1
(43) Pub. Date: Nov. 12, 2015

(54) FOLDABLE WIRELESS CHARGING SYSTEM

(71) Applicant: LENOVO (SINGAPORE) PTE. LTD., Singapore (SG)

(72) Inventors: Masayuki Amano, Kanagawa-ken (JP); Yasumichi Tsukamoto, Kanagawa-ken (JP); Takehito Yamauchi, Kanagawa-ken (JP); Yoshio Nakamura, Kanagawa-ken (JP); Shinnosuke Takahashi, Kanagawa-ken (JP)

(73) Assignee: LENOVO (SINGAPORE) PTE. LTD., Singapore (SG)

(21) Appl. No.: 14/274,276

(22) Filed: May 9, 2014

(51) Int. Cl. H02J 7/02; H02J 7/00

(52) U.S. Cl. CPC H02J 7/025; H02J 7/0052; H02J 7/0044

(57) ABSTRACT

A wireless charging system may provide charging to a portable device. A docking station in the system may include a first transmission source configured to emit wireless charging power along a first transmission axis from a first body. The docking station may include a second power transmission source configured to emit wireless charging power along a second transmission axis from a second body. In some embodiments, the first transmission axis may not intersect with the second transmission axis. In some embodiments, the first transmission axis may be divergent from the second transmission axis.

### BACKGROUND OF THE INVENTION

The present invention generally relates to electronic accessories and, more particularly, to a foldable wireless charging system.

Some portable electronic devices may include multiple displays. For example, some mobile phones, game systems, and computing devices use two displays in juxtaposition. Conventionally, these devices are re-charged via wired connection to an outlet.

Typically, a charger on the device is plugged into a power source to recharge. In multi-display devices, the charger may be found on one side of the device due to space and cost considerations in designing the device. Thus, when re-charging the device, the device may be required to dock onto a charging station in one orientation.

Some chargers may use a resonance system to provide wireless charging across large distances. Output from separate resonators may be pointed in convergence to use constructive wave interference to amplify the signal.

As can be seen, there is a need for a charging system that allows charging of electronic devices in more than one orientation on the charging dock.

### SUMMARY OF THE INVENTION

In one aspect of the present invention, a docking station for charging a portable device comprises a first body; a first transmission source configured to emit wireless charging power along a first transmission axis from the first body; a second body rotatable with respect to the first body; and a second power transmission source configured to emit wireless charging power along a second transmission axis from the second body, wherein the first transmission axis does not intersect with the second transmission axis.

In another aspect of the present invention, a docking station for charging a portable device comprises a first transmission source disposed to emit wireless power in a first direction and a second transmission source disposed to emit wireless power in a second direction, wherein, when the docking station is in: a first mode, the first direction is substantially parallel to the second direction, and a second mode, first direction is divergent from the second direction.

In another aspect of the present invention, a wireless charging system comprises a portable device; and a foldable docking station configured to receive the portable device for charging, including: a first transmission source configured to emit wireless charging power along a first transmission axis; and a second power transmission source configured to emit wireless charging power along a second transmission axis, wherein the first transmission axis is divergent from the second transmission axis.

These and other features, aspects and advantages of the present invention will become better understood with reference to the following drawings, description and claims.

### BRIEF DESCRIPTION OF THE DRAWINGS

FIG. 1A is a front perspective view of a charging system according to an exemplary embodiment of the present invention;

FIG. 1B is the charging system of FIG. 1A with a portable device docked in a tented mode;

FIG. 1C is the charging system of FIG. 1A with a docking station in a closed mode;

FIG. 1D is the charging system of FIG. 1A with the docking station in a flat mode;

FIG. 2A is a cross-sectional end view of the docking station of FIG. 1C;

FIG. 2B is a cross-sectional end view of the docking station of FIG. 1A;

FIG. 2C is a cross-sectional end view of the docking station of FIG. 1D;

FIGS. 3A and 3B are enlarged partial views of the circle 3 of FIG. 1A according to an exemplary embodiment of the present invention; and

FIG. 4 is a block diagram of the charging system of FIG. 1A according to an exemplary embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

The present invention generally provides a charging system for wirelessly charging portable electronic devices. In particular, the charging system may provide charging for devices that include multiple segments. The devices may thus be movable into various configurations. Each of the segments may include a charger element configured to receive wireless power and exemplary embodiments of the present invention may charge the device as it rests on a docking station of the charging system in one of multiple orientations. In addition, the docking station may be reconfigurable into a plurality of docking modes. The docking station may provide versatility by supporting one or more devices docked in various orientations. For example, multiple devices may be charged simultaneously on different surfaces of the docking station. In another example, for devices with multiple segments, the docking station may support one segment on one side of the docking station and a second segment on a second side. The two segments may provide separate output functions while charging.

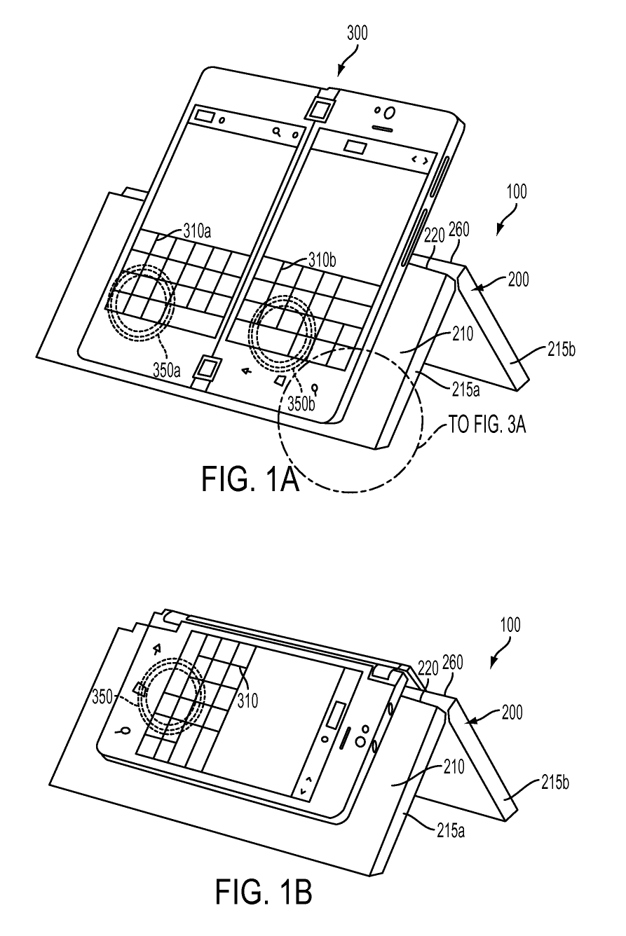

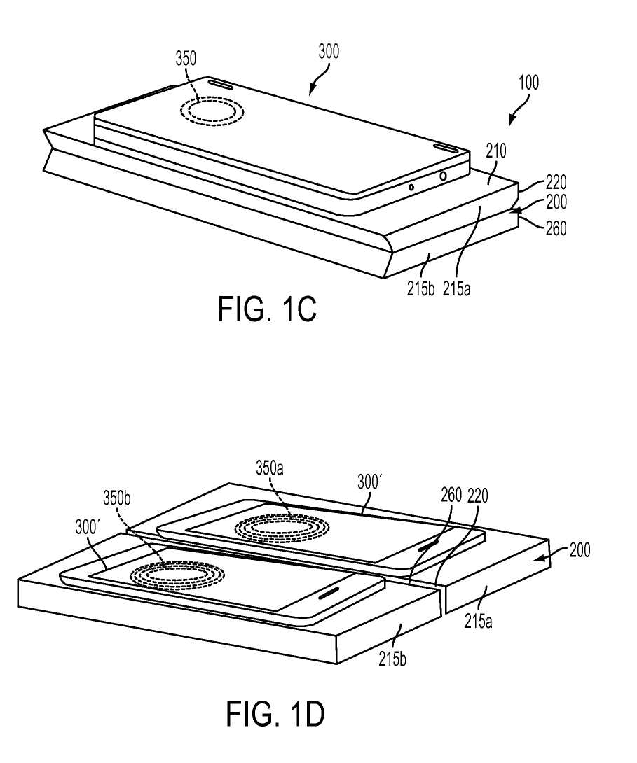

Referring to FIGS. 1A, 1B, 1C, and 1D a wireless charging system 100 is shown according to an exemplary embodiment of the present invention. In general, the wireless charging system 100 may include a docking station 200 and a portable device 300.

In the embodiments of FIGS. 1A, 1B, and 1C, the portable device 300 may include a first device segment 310a and a second device segment 310b (referred to in general as device segments 310). In some embodiments, the portable device 300 may be a multi-display device. The first device segment 310a may include a charger 350a. The second device segment 310b may include a second charger 350b. While the first charger 350a and the second charger 350b are shown visible, it will be understood that these chargers may generally be housed inside the first and second device segments 310a and 310b. The chargers 350a and 350b may be configured to receive a wireless power charge from the docking station 200.

In another embodiment, (FIG. 1D) the portable device (designated by numeral 300′) may have only a single device segment 310 and a single charger therein.

The docking station 200 may be reconfigurable into different modes for supporting the portable device 300. FIG. 1A shows the docking station 200 in a tent mode with the portable device 300 supported in a standing, inclined orientation. FIG. 1B shows the docking station 200 in a tent mode and the portable device 300 in a device tent mode. FIG. 1C shows the docking station 200 in a closed, folded mode. FIG. 1D shows the docking station 200 in an open, flat mode.

The docking station 200 may include a docking surface 210 upon which the portable device 300 may rest. The docking station 200 may include a first body 215a and a second body 215b. In some configurations, the docking surface 210 may be split into multiple portions. Wireless power transmission may be provided from either the first body 215a and/or the second body 215b in a direction toward the nearest device segment 310 as described further below.

Referring to FIGS. 1A and 1B, the docking station 200 may be foldable, wherein the first body 215a may be pivoted from the second body 215b along the hinge 220 to form a ridge 260. In FIG. 1A, the first and second device segments 310a and 310b may stand resting against the first body 215a during charging (although it is understood that the first and second device segments 310a and 310b may likewise rest against the second body 215b).

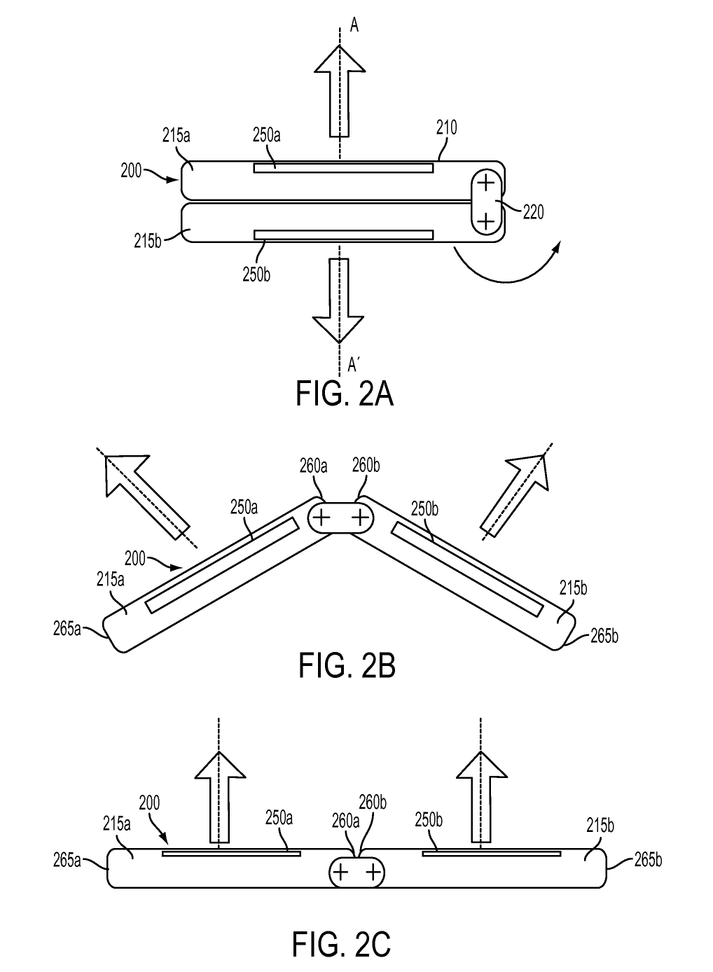

In FIG. 1B, the portable device 300 may be docked onto the ridge 260 so that the first device segment 310a abuts the first body 215a during charging and the second device segment 310b abuts the second body 215b during charging. The portable device 300 may have the first charger 350a in the first device segment 310a and the second charger 350b in the second device segment 310b. The wireless charging system 100 may have a transmission source 250a in the first body 215a and a transmission source 250b in the second body 215b as in later described in FIG. 2. The first charger 350a may receive power from the transmission source 250a and the second charger 350b may receive power from the second transmission source 250b simultaneously so that charging speed is doubled.

In FIG. 1C, the docking station 200 may be folded so that the first body 215a is pivoted on the hinge 220 in abutment and atop the second body 215b.

In FIG. 1D, the docking station 200 may be opened flat so that the first body 215a may be co-planar and juxtaposed to the second body 215b. A first portable device 300′ may lay flat against the first body 215a and a second portable device 300′ may lay flat against the second body 215b during charging. The both two portable device 300′ may receive power each from the transmission source 250a and transmission source 250b simultaneously.

Referring now to FIGS. 2A, 2B, and 2C, wireless power transmission from the docking station 200 is shown according to exemplary embodiments of the present invention. The hinge 220 may be a multi-axis hinge that provides pivoting of the first body 215a about the hinge 220 independent of pivoting of the second body 215b about the hinge 220. As shown in FIGS. 2A, 2B, and 2C, the docking station 200 is reconfigured from a closed state (closed mode) (FIG. 2A) by pivoting the first body 215a and the second body 215b about the hinge 220 into a partially open state (tent mode) (FIG. 2B) and then into a fully open state (flat mode) (FIG. 2C). In FIG. 2B, the ridge 260 may be provided by interior edges 260a and 260b. Tent mode may be defined by a distance between the interior edges 260a and 260b being less than a distance between exterior edges 265a and 265b.

The docking station 200 may include a first transmission source 250a in the first body 215a and a second transmission source 250b in the second body 215b. The first and second transmission sources may be referred to generally as transmission source(s) 250. In an exemplary embodiment, the transmission sources 250 may be inductance coils. The transmission sources 250 may emit wireless power in a direction that is perpendicular to their respective first body 215a or second body 215b. In an exemplary embodiment, the emission from a transmission source 250 may be primarily uni-directional so that a majority of the electro-magnetic field is emitted in the direction of the charger 350 (FIG. 1A). In general, the emission from transmission source 250a may not intersect the emission from the transmission source 250b.

For example, in FIG. 2A (closed mode), the transmission source 250a may emit wireless power along an axis A. The transmission source 250b may stop emitting wireless power along an axis A′. In the closed mode, the emission from transmission source 250a is primarily in the opposite direction of the emission from the transmission source 250b if it were activated.

In FIG. 2B, with the docking station 200 in the tent mode, the transmission source 250a may emit wireless power in a direction that may be divergent from the emission of transmission source 250b.

In FIG. 2C, with the docking station 200 in flat mode, the transmission source 250a may emit wireless power in a direction that may be parallel to the emission of transmission source 250b.

By providing the power so that the emission from respective transmission sources 250 does not intersect, the amount of power being supplied to a charger 350 (FIG. 1A) may be predicted. Thus, control over charging more than one charger 350 (FIG. 1A) may be controlled according to the predicted output from the docking station 200.

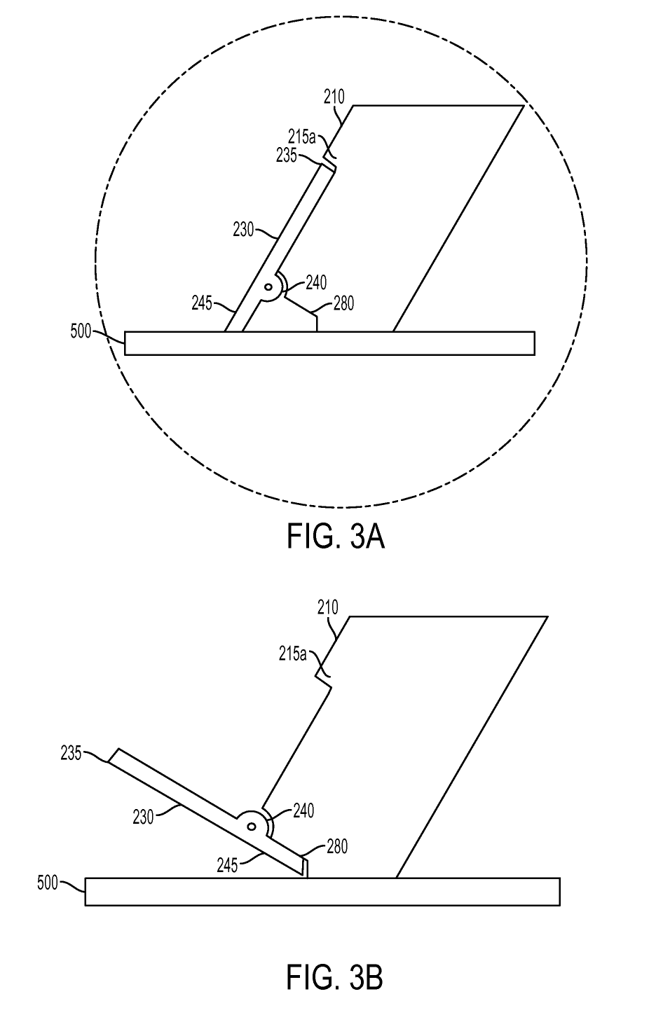

Referring now to FIGS. 3A and 3B, a ledge 230 of the docking station 200 is shown for supporting the portable device 300 (FIG. 1A) according to an exemplary embodiment of the present invention. The portable device 300 is removed from view for sake of illustration. The ledge 230 may be helpful in supporting the portable device 300 (FIG. 1A) docked, for example, when the docking station 200 (FIG. 1A) is in the tent mode. The first body 215a may rest on a support surface 500. The support surface 500 may be for example, a table, shelf, or nightstand. The ledge 230 may be attached to the docking surface 210 side of the first body 215a. The ledge 230 may include a spring-loaded hinge 240 so that a first end 235 may rotate away from the first body 215a and a second opposite end 245 may rotate inward into a chamber 280 of the first body 215a. While the foregoing was described with respect to the ledge 230 being coupled to the first body 215a, it will be understood that the second body 215b (FIG. 1A) may also include the ledge 230.

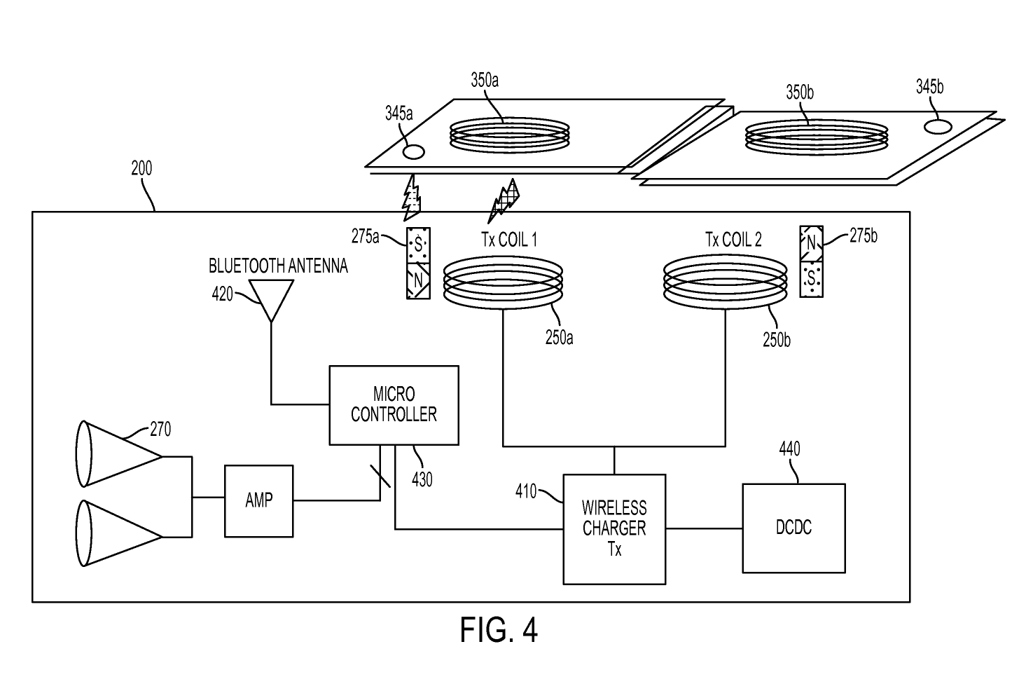

Referring now to FIG. 4, the wireless charging system 100 is shown with further internal components of the docking station 200 in accordance with an exemplary embodiment of the present invention. A wireless charging transmitter 410 may control charging from the transmission sources 250a and 250b, respectively. The docking station 200 may use a polling technique to determine whether the portable device 300 is in charging range of either of the transmission sources 250a or 250b. In an exemplary embodiment, a transceiver 420 may transmit a polling signal. In some embodiments, the transceiver 420 may be a Bluetooth® device. A microcontroller 430 may control the frequency of polling transmissions and the condition for determining a successful detection of the portable device 300. In an exemplary embodiment, the microcontroller 430 may determine whether the charger 350a or charger 350b is closer to either the transmission source 250a or the transmission source 250b (for example, by receiving a signal indicating that a Hall effect sensor 345a or 345b detects the presence of a magnet 275a or 275b). The microcontroller 430 may activate the wireless charging transmitter 410 to provide power from a power source 440 to the transmission sources (250a or 250b) that is in charging range of either the charger 350a or the charger 350b. The microcontroller 430 may also be configured to provide auxiliary functions of the portable device 300 through the docking station 200. For example, in some embodiments, audio files from the portable device 300 may be received at the microcontroller 430 and played via the speakers 270.

It should be understood, of course, that the foregoing relates to exemplary embodiments of the invention and that modifications may be made without departing from the spirit and scope of the invention as set forth in the following claims.

What is claimed is:

1. A docking station for charging a portable device, comprising:
a first body;
a first transmission source configured to emit wireless charging power along a first transmission axis from the first body;
a second body rotatable with respect to the first body; and
a second power transmission source configured to emit wireless charging power along a second transmission axis from the second body, wherein the first transmission axis does not intersect with the second transmission axis.

2. The docking station of claim 1, wherein the first power transmission source and the second power transmission source are inductive coils.

3. The docking station of claim 1, wherein the hinge is a multi-axis hinge.

4. The docking station of claim 1, wherein a direction of transmission for the second power transmission source is uni-directional along the second transmission axis.

5. The docking station of claim 1, further comprising a ledge on the first body or the second body configured to support the portable device.

6. The docking station of claim 5, wherein the ledge is spring loaded and configured to move from a first position to a second position.

7. A docking station for charging a portable device, comprising:
a first transmission source disposed to emit wireless power in a first direction and a second transmission source disposed to emit wireless power in a second direction,
wherein, when the docking station is in:
a first mode, the first direction is substantially parallel to the second direction, and
a second mode, first direction is divergent from the second direction.

8. The docking station of claim 7, further comprising a hinge connecting a first body of the docking surface to a second body of the docking surface.

9. The docking station of claim 8, wherein the hinge is a multi-axis hinge.

10. The docking station of claim 9, wherein the docking surface is configured to provide emission of wireless power in a third mode that includes the first direction being opposite to the second direction.

11. The docking station of claim 7, further comprising a ledge on the docking surface configured to support the portable device in the second mode.

12. The docking station of claim 11, wherein the ledge is angled from a support surface.

13. The docking station of claim 12, wherein the ledge is spring loaded and configured to move from a first position to a second position.

14. The docking station of claim 7, wherein the docking surface is foldable.

15. A wireless charging system, comprising:
a portable device; and
a foldable docking station configured to receive the portable device for charging, including:
a first transmission source configured to emit wireless charging power along a first transmission axis; and
a second power transmission source configured to emit wireless charging power along a second transmission axis, wherein the first transmission axis is divergent from the second transmission axis.

16. The system of claim 15, wherein the first device segment is pivotally attached to the second device segment.

17. The system of claim 15, further comprising a hinge connecting a first body of the docking surface to a second body of the docking surface.

18. The system of claim 17, wherein the foldable docking station is configured to support the portable device along a ridge of the foldable docking station.

19. The system of claim 18, wherein the ridge includes the hinge.

20. The system of claim 15, wherein the first transmission axis does not intersect with the second transmission axis.
